(19) United States
(12) Patent Application Publication
(10) Pub. No.: US 2006/0218200 A1
(43) Pub. Date: Sep. 28, 2006

(54) Application of log records by storage servers

(75) Inventors: Michael Factor, Haifa (IL); Julian Satran, Atlit (IL); Gary Valentin, Tel Aviv-Jaffa (IL); Aviad Zlotnick, D.N. Galil Tachton (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/088,701

(22) Filed: Mar. 24, 2005

(51) Int. Cl. G06F 17/30

(52) U.S. Cl. 707/200

(57) ABSTRACT

Logging and storage transactions in a database are directed to a single storage server. A modification of a database record is written only once to a log record on the storage server. Subsequently, the storage server interprets the database log records, and modifies the database storage accordingly. The number of bytes written to storage is potentially reduced by fifty percent as compared to writing the log record and then writing the modified database record to the storage server.

### BACKGROUND OF THE INVENTION

1. Field of the Invention

This invention relates to computer databases. More particularly, this invention relates to improvements in database performance by elimination of redundant processing on the database host and storage servers.

2. Description of the Related Art

When a database manager commits modified data to storage, it does so in two steps: first, by describing the data modification in a log record, and second, by performing the modification in a final storage location. The considerations in this scheme include the need to minimize data loss in the event of system failure, balanced against the need to maximize transaction processing speed. Some message queuing systems have the same general requirement, and also perform redundant write operations.

Most existing protocols present storage servers simply as resources having write and read data buffers. Logs are used in order to write the data in a sequential fashion. The logs can be revisited later in order to undo specific modifications, or to redo modifications on backup images.

In one approach, known as log-shipping, the database manager ships the log records to a host in a secondary site, to be applied on a mirrored database at the secondary site. This solution requires two host servers and two storage servers. While this technique provides redundancy, performance is still limited by the need to communicate each data modification twice, once from each host server to a storage device.

A logged file system is proposed in U.S. Pat. No. 5,832,515 to Ledaine et al., in which data is output to a log pseudo-device driver, bypassing the operating system's main data pathways for output. Using this arrangement, it is suggested that a host can control logging for a file system on a separate device to improve file system performance. The data is written to a log device disk, eventually being migrated to a main disk by the host. Exceptionally, large writes may be directed directly to the main disks, rather than to the log device, but more commonly, smaller writes cannot. While there is provision to use the log device exclusively for data storage in order to avoid data migration, this is feasible only in situations in which write operations are infrequent, and read operations predominate.

There remains a need to minimize I/O operations in order to reduce traffic between different disk storage systems in order to optimize database performance.

### SUMMARY OF THE INVENTION

According to a disclosed embodiment of the invention, all logging and storage issues in a database are directed to a single storage server. A modification of a database record is written only once from the host server to a log record on the storage server, instead of being written twice, once to the log record and again to a storage server when the page containing the data is flushed out. Subsequently, the storage server interprets the database log records, and modifies the database storage accordingly. Using this method, the number of bytes written from the host to the storage server is potentially reduced by fifty percent.

Unlike the disclosure of the above-noted U.S. Pat. No. 5,832,515, in which a main disk device driver is responsible for communication between the log and main disk controllers, according to some aspects of the present invention, logic for applying log records has been removed from the host and placed in a storage device. After the log entry is written the storage device operates autonomously with respect to the log entry. This saves host resources and also avoids two data transfers—from the log device to the host, and from the host to the main device. The inventive arrangement is particularly advantageous in a network storage environment.

One embodiment of the present invention provides a method of modifying a computer-implemented database, which is carried out by executing a database manager on a host server, preparing a modification of a database record of the database on the host server, transmitting a log entry indicative of the modification exactly one time from the host server to a storage server that holds the database record, the log entry including less information than the database record, and interpreting the log entry on the storage server. Responsively to the interpretation of the log entry, the storage server updates the database record according to the modification communicated in the log entry.

According to one aspect of the method, the log entry is an instruction to the storage server for updating the database record responsively to the modification.

In one aspect of the method, the storage server has a database table space and a plurality of logical volumes. The method is further carried out by designating one of the logical volumes as a log volume to receive the log entry, establishing a one-to-one mapping between the database table space and the log volume, and identifying the database record using the mapping.

In another aspect of the method, updating the database record includes establishing a copy of the database manager on the storage server, and executing the copy to identify the database record and to apply the log entry for updating thereof. Optionally, the method includes establishing a virtual machine in the storage server, wherein the copy is a component of the virtual machine.

In yet another aspect of the method, updating the database record includes emulating the database manager on the storage server to identify the database record and to apply the log entry for updating thereof.

Still another aspect of the method includes maintaining a heartbeat synchronization between the host server and the storage server.

In an additional aspect of the method, subsequent to transmitting a log entry and prior to completing the update of the database record by the storage server, a read operation that may be initiated on the database record is thereafter delayed until completion of the update of the database record by the storage server.

An embodiment of the present invention provides a computer software product, including a computer-readable medium in which computer program instructions are stored, which instructions, when read by one or more computers, cause the computers to perform a method for modifying a database, which is carried out by executing a database manager on a host server, preparing a modification of a database record of the database on the host server, transmitting a log entry indicative of the modification exactly one time from the host server to a storage server that holds the database record, the log entry including less information than the database record, interpreting the log entry on the storage server. Responsively to the interpretation of the log entry, the storage server updates the database record according to the modification communicated in the log entry.

An embodiment of the present invention provides a database management system, including a host server that has a database manager executing thereon. The host server is operative to prepare a modification of a database record that is managed by the database manager. The system further includes a storage server that stores the database record, and is linked to the host server. The storage server is operative for accepting a transmission of the modification exactly one time as a log entry from the host server, the log entry describing the modification and including less information than the database record. The storage server is operative to update the database record responsively to the log entry.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram of a computer-implemented database system, which is constructed and operative in accordance with a disclosed embodiment of the invention;

FIG. 2 is a block diagram of a storage server for use in the system shown in FIG. 1, which is constructed and operative in accordance with a disclosed embodiment of the invention;

FIG. 3 is a block diagram of a storage server for use in the system shown in FIG. 1, which is constructed and operative in accordance with an alternate embodiment of the invention;

FIG. 4 is a block diagram of a storage server for use in the system shown in FIG. 1, which is constructed and operative in accordance with an alternate embodiment of the invention; and

FIG. 5 a flow chart illustrating a method of applying log records on a storage server by delaying read operations in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client-server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

System Architecture

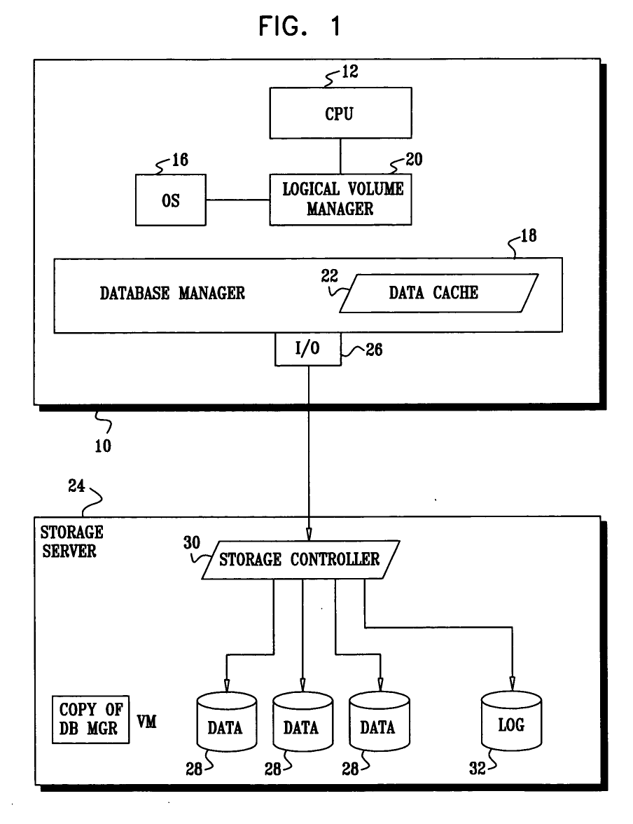

Turning now to the drawings, reference is initially made to FIG. 1, which is a block diagram of a computer-implemented database system, which includes a host server 10, and which is constructed and operative in accordance with a disclosed embodiment of the invention. The host server 10 can be realized as a conventional computer, workstation, or a networked arrangement of computing devices. The host server 10 includes at least one CPU 12, a suitable memory for an operating system 16, application programs and data. In particular the memory includes an executing database manager 18. The operating system 16 includes, or is linked to a logical volume manager 20. Typically, a data cache memory 22 is available to the database manager 18 in order to improve its performance. A storage server 24 may be co-located with the rest of the system or remotely located and connected via a data network, for example a storage area network (SAN). In any case the storage server 24 is interoperable with the database manager 18 via an I/O facility 26, and its data 28 may be accessed via a storage controller 30, using calls of the operating system 16, or more directly by the database manager 18. In contrast with conventional database systems, the host server 10 is not provided with a separate log server for maintaining transaction logs. Instead, as is disclosed in further detail hereinbelow, transaction logs 32 are processed directly on the storage server 24.

In the following embodiments, the storage server 24 is adapted to process the format of database log records, either by using the proprietary log formats of the database manager 18, or through an open implementation, which supports any application that enables writing database transactions as physical log records. The principles of the invention are described in these embodiments with reference to traditional database systems. However, they are equally applicable to variants, e.g., message queuing systems, in which a permanent record needs to be stored and referenced.

The log records that are written by the host server 10 to the storage server 24 are not complete database records. Rather in some embodiments, they are a journal of modifications to specific portions or fields of the database records. The information in the log record is interpretable on the storage server 24. Alternatively, the log records may be coded or uncoded instructions. In either case, when the information or the instructions are interpreted on the storage server 24, the storage server 24 executes operations to bring the data structures of the target database into a consistent and up-to-date state responsively to the transaction performed in the host server 10. These records are typically condensed, as compared with an entire database record, and thus can be transmitted using relatively little bandwidth.

Log records written to the storage server 24 and the files in which they are stored differ substantially from conventional log-structured file systems and variants thereof. To emphasize the difference, a brief summary of log-structured file systems is presented. A log-structured file system provides for permanent recording of write file data in an effectively continuous sequential log. Typically, data is intentionally written as received continually, appended to the end of the active log. Thus, the effective data bandwidth required can approximate the bandwidth of the disk drive mass storage subsystem. All seek operations for writes are minimized as file data is written to the end of the active log. However, read data, as well as cleaning and data block maintenance operations, produce many seek operations. Log-structured file systems are, however, not entirely effective in all computing environments. For example, log-structured file systems show little improvement over conventional file systems where the computing environment is subject to a large percentage of fragmentary data writes and sequential data reads such as may occur frequently in transactional data base applications. The write data optimizations provided by log-structured file systems can also be rather inefficient in a variety of other circumstances as well, for example, when random and small data block read accesses are dominant. A further description of log-structured file systems is given in the above-noted U.S. Pat. No. 5,832,515, which is herein incorporated by reference.

By looking at the data flow between the storage and host, in particular when using external storage, e.g., a network storage environment, application of the inventive principles described above should require about one third of the bandwidth on the storage network in comparison with the system disclosed in the above-noted U.S. Pat. No. 5,832,515.

Storage Server—Embodiment 1

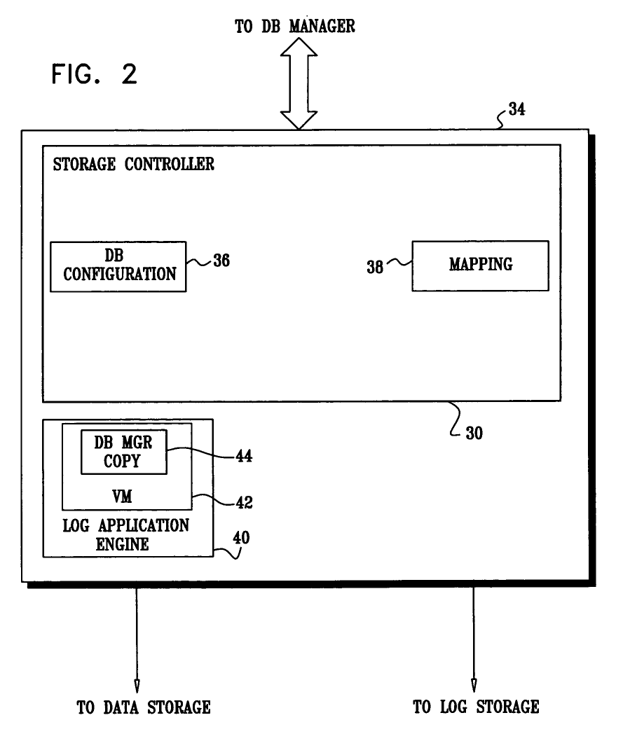

Reference is now made to FIG. 2, which is a block diagram illustrating details of a server 34, which is constructed and operative in accordance with a disclosed embodiment of the invention, and which can be used as the storage server 24 (FIG. 1). The server 34 is capable of differentiating logical units of data that refer to logs and from those that refer to data. The database configuration is predefined, and is available to the storage controller 30, as shown in a configuration block 36. In the configuration of the storage server, a logical volume is designated as a log volume by the logical volume manager 20 (FIG. 1). A mapping 38 is provided for the log volume that identifies the structure and location of database tables on the storage server or on other storage servers in the case of a distributed database. Within the context of the configuration block 36, this is accomplished by assigning the type of storage object as an object property, with “logs” being a first object property corresponding to the log device. A second “data” object property corresponds to data objects, with a reference to the log device that affects them. Without the configuration block 36, it would be necessary to transfer configuration information from the host server 10 using the operating system 16, and the logical volume manager 20 (FIG. 1).

For simplification of presentation it is assumed that there is a one-to-one mapping 38 between database table space and logical volumes of disks on the storage server. This implies a trivial role for the logical volume manager 20. It will be understood that in more complicated database systems such a simple mapping does not exist. Nevertheless, those skilled in the art can develop a mapping appropriate to a given database system configuration.

It is recommended that the mapping be verified, as its integrity is essential for proper function of the storage controller 30.

This implementation requires special handling of data read requests, particularly in cases where the application of corresponding log entries has not yet completed. Provision for such data reads can be accomplished in two ways. In a first alternative, the storage controller 30 applies all log records in real time on the requested database page read. In a second alternative, the read request is delayed until the storage controller 30 updates the database page, thereby insuring that the reading process receives its current version. The second alternative is shown in further detail in Example 1 below.

The server 34 includes a log application engine 40, which applies log transactions in accordance with the format of database storage records in order to update the database records. It should be noted that the log application engine 40 is independent of any disaster recovery mechanisms, which are often based on a primary site and a secondary site. As noted above, a secondary site is not required for the implementation of the log application engine 40. The storage controller 30 is a high-end device, providing full support for applications, including support for an operating system environment. Thus it is feasible to implement the log application engine 40 by establishing a virtual machine 42 on the server 34, and including an instance or copy of the database manager copy 44 as a component of the virtual machine 42. Alternatively, only a portion of the database manager code is placed in the virtual machine 42, no more than is necessary to perform log application functions. The necessary code can be implemented either as a shared library or as an executable.

Storage Server—Embodiment 2

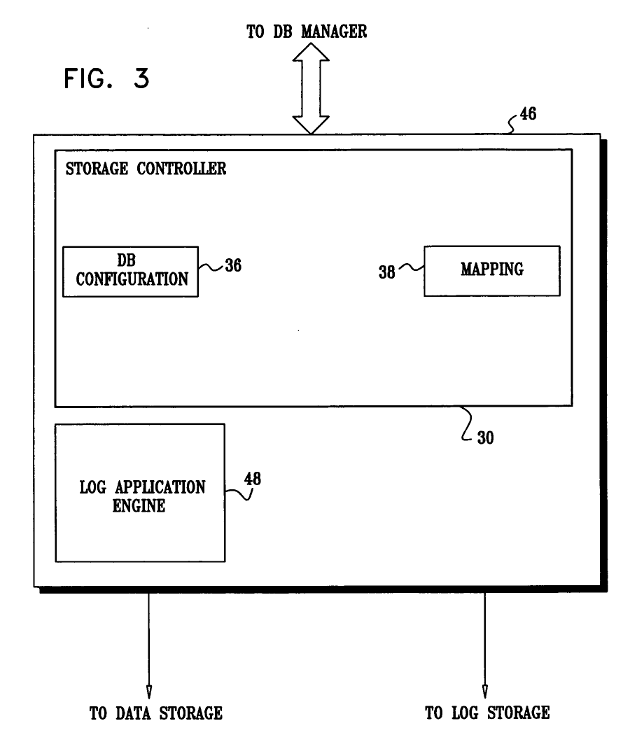

Reference is now made to FIG. 3, which is a block diagram of a server 46, which is constructed and operative in accordance with an alternate embodiment of the invention, and which can be used as the storage server 24 (FIG. 1). The server 46 is similar to the server 34 (FIG. 2), but instead of employing a virtual machine, a log application engine 48 is implemented as a software program at the application level, which emulates the database manager operations. Alternatively, the log application engine 48 may handles a more generic form of log application.

Storage Server—Embodiment 3

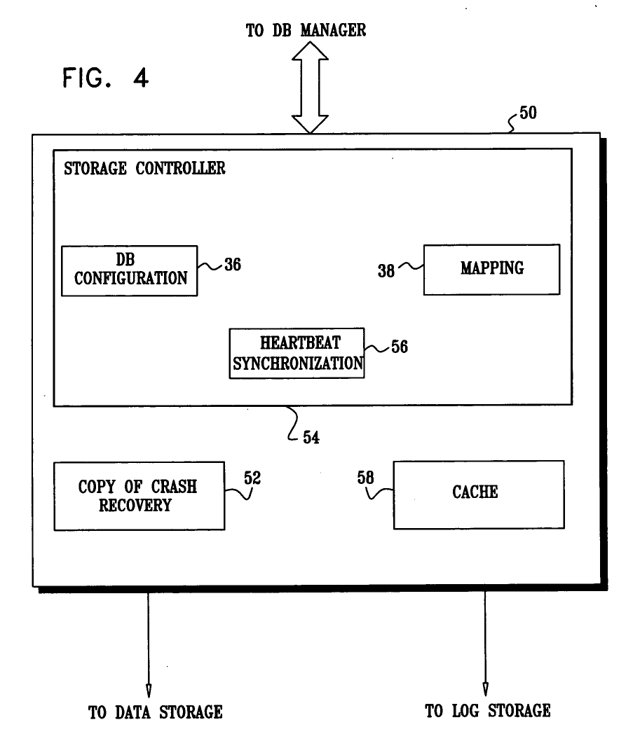

Reference is now made to FIG. 4, which is a block diagram of a server 50, which is constructed and operative in accordance with an alternate embodiment of the invention, and which can be used as the storage server 24 (FIG. 1). This embodiment takes advantage of log-shipping functionality inside the database manager, also known as high-availability data replication. This functionality is available on several commercial database managers, for example the DB2 product family, available from International Business Machines Corporation, New Orchard Road, Armonk, N.Y. 10504. The server 50 is treated by the database manager 18 (FIG. 1) as a secondary server, which keeps a consistent copy of the primary server's crash recovery procedures 52. This architecture may be further optimized to anticipate crash recovery using a modified storage controller 54. A synchronization process 56 in the storage controller 54 maintains a heartbeat with the database manager. If the heartbeat fails, then all uncompleted transactions must be rolled back. Alternatively, in a simpler implementation, one simply populates a cache 58 with pages, which will be needed during crash recovery, thus avoiding the random I/O costs during crash recovery.

In the above described embodiments of the present invention, only a primary server exists for local log application activity. Optionally, a secondary server may exist in order to perform substantially real time log application. Alternatively, both a primary and a secondary server may perform log application activity substantially in real time. If there are multiple controllers, applying the log entries and servicing reads is much more difficult. The servers have to cooperatively maintain a system of tables indicating which tables have been modified. In any case, only one write operation for each log transaction need be executed by the database manager 18 (FIG. 1) to the target that was designated as a log device during server configuration. Subsequently, writes to more than one disk or file system may occur as a consequence of activity in the log device itself.

### EXAMPLE 1

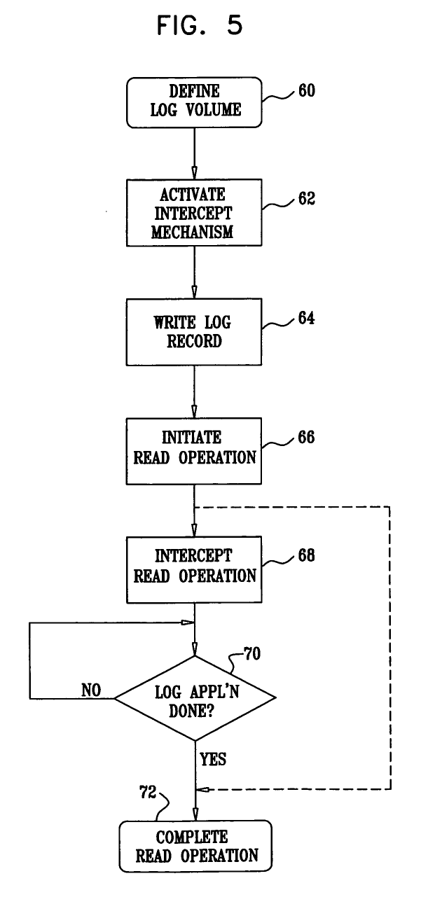

Reference is now made to FIG. 5, which is a flow chart illustrating a prospective example, wherein log records are applied on a storage server in accordance with a disclosed embodiment of the invention. The process steps are shown in a particular sequence in FIG. 5 for clarity of presentation. However, it will be evident that many of them can be performed in parallel, asynchronously, or in different orders.

The process begins at initial step 60, where a log volume is defined, typically by setting a bit in a configuration table of the storage server.

Next, at step 62, an existing pre-write and post-write intercept mechanism on the storage server is used to activate a background log application process that will apply newly written log entries to the database tables.

Next, at step 64, a log record of a creation or other modification of a database record is written out to the storage server.

Next, at step 66 an attempt is initiated to read the database record that was affected by the write operation in step 64.

Next, at step 68 a read intercept occurs in order to prevent the read operation initiated in step 66 from reading out-of-date data. In applications involving high transaction volumes, it is likely that data related to newly written log updates is still in the database buffer pool. Thus, a read operation on data that is still waiting for the background log application process to complete is likely to be rare.

Control now proceeds to delay step 70, where the read operation waits until the background log application process finishes the update. The delay is only necessary if there is a log entry relevant to the data being read. This delay step is particularly desirable when the log volume defined in initial step 60 is in the same storage device as the related database tables. However, even when this is not the case, there may still be some benefits (mostly in terms of the database server CPU utilization), although communication between the log volume and other devices on which table data is stored will be required.

Alternatively, a new log entry may be processed in real time, in which case step 68 and delay step 70 can be omitted, as shown by the broken line in FIG. 5.

At final step 72, the read operation completes.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A method of modifying a computer-implemented database, comprising the steps of:
executing a database manager on a host server for managing said database;
on said host server preparing a modification of a database record of said database;
transmitting a log entry indicative of said modification exactly one time from said host server to a storage server that holds said database record, said log entry comprising less information than said database record;
interpreting said log entry on said storage server; and
wherein responsively to said interpretation of said log entry said storage server updates said database record responsively to said modification.

2. The method according to claim 1, wherein said log entry is an instruction to said storage server for updating said database record responsively to said modification.

3. The method according to claim 1, wherein said storage server has a database table space and a plurality of logical volumes, further comprising the steps of:
designating one of said logical volumes as a log volume to receive said log entry;
establishing a one-to-one mapping between said database table space and said log volume; and
identifying said database record using said mapping.

4. The method according to claim 1, wherein said step of updating said database record comprises the steps of:
establishing a copy of said database manager on said storage server; and
executing said copy to identify said database record and to apply said log entry for updating thereof.

5. The method according to claim 4, further comprising the step of establishing a virtual machine in said storage server, wherein said copy is a component of said virtual machine.

6. The method according to claim 1, wherein said step of updating said database record comprises the step of:
emulating said database manager on said storage server to identify said database record and to apply said log entry for updating thereof.

7. The method according to claim 1, further comprising the steps of maintaining a heartbeat synchronization between said host server and said storage server.

8. The method according to claim 1, further comprising the steps of:
subsequent to performing said step of transmitting a log entry and prior to completing said update of said database record by said storage server, initiating a read operation on said database record; and
thereafter delaying said read operation until completion of said update of said database record by said storage server.

9. The method according to claim 1, further comprising the steps of:
subsequent to performing said step of transmitting a log entry and prior to completing said update of said database record by said storage server, initiating a read operation on said database record; and
thereafter immediately applying said log entry to update said database record.

10. A computer software product, including a computer-readable medium in which computer program instructions are stored, which instructions, when read by one or more computers, cause the computers to perform a method for modifying a database, comprising the steps of:
executing a database manager on a host server for managing said database;
on said host server preparing a modification of a database record of said database;
transmitting a log entry indicative of said modification exactly one time from said host server to a storage server that holds said database record, said log entry comprising less information than said database record;
interpreting said log entry on said storage server; and
wherein responsively to said interpretation of said log entry said storage server updates said database record responsively to said modification.

11. The computer software product according to claim 10, wherein said log entry is an instruction to said storage server for updating said database record responsively to said modification.

12. The computer software product according to claim 10, wherein said storage server has a database table space and a plurality of logical volumes, further comprising the steps of:
designating one of said logical volumes as a log volume to receive said log entry;
establishing a one-to-one mapping between said database table space and said log volume; and
identifying said database record using said mapping.

13. The computer software product according to claim 10, wherein said step of updating said database record comprises the steps of:
establishing a copy of said database manager on said storage server; and
executing said copy to identify said database record and to apply said log entry for updating thereof.

14. The computer software product according to claim 13, further comprising the step of establishing a virtual machine in said storage server, wherein said copy is a component of said virtual machine.

15. The computer software product according to claim 10, wherein said step of updating said database record comprises the step of:
emulating said database manager on said storage server to identify said database record and to apply said log entry for updating thereof.

16. The computer software product according to claim 10, further comprising the steps of maintaining a heartbeat synchronization between said host server and said storage server.

17. The computer software product according to claim 10, further comprising the steps of:
subsequent to performing said step of transmitting a log entry and prior to completing said update of said database record by said storage server, initiating a read operation on said database record; and
thereafter delaying said read operation until completion of said update of said database record by said storage server.

18. The computer software product according to claim 10, further comprising the steps of:
subsequent to performing said step of transmitting a log entry and prior to completing said update of said database record by said storage server, initiating a read operation on said database record; and
thereafter immediately applying said log entry to update said database record.

19. A database management system, comprising:
a host server having a database manager executing thereon, said host server being operative to prepare a modification of a database record that is managed by said database manager;
a storage server that stores said database record, said storage server being linked to said host server and accepting a transmission of said modification exactly one time as a log entry from said host server, said log entry describing said modification and comprising less information than said database record; and
said storage server being operative to update said database record responsively to said log entry.

20. The database management system according to claim 19, wherein said storage server has a database table space and a plurality of logical volumes, said storage server having a one-to-one mapping between said database table space and said logical volumes, said storage server being operative to identify said database record using said mapping.

21. The database management system according to claim 19, wherein said storage server has a copy of said database manager executing thereon to identify said database record and to apply said log entry for updating thereof.

22. The database management system according to claim 21, wherein said storage server has a virtual machine executing thereon, wherein said copy is a component of said virtual machine.

23. The database management system according to claim 19, wherein said storage server has an emulator of said database manager executing thereon to identify said database record and to apply said log entry for updating thereof.

24. The database management system according to claim 19, wherein said host server and said storage server are operative to maintain a heartbeat synchronization therebetween.

25. The database management system according to claim 19, wherein said storage server is operative to delay a read operation on said database record that is initiated subsequent to said transmission of said modification until completion of an updating of said database record by said storage server.

26. The database management system according to claim 19, wherein said storage server is operative subsequent to transmission of said log entry and prior to completion of said update of said database record by said storage server, for responding to a read operation on said database record by immediately applying said log entry to update said database record.
